(19) United States
(12) Patent Application Publication
(10) Pub. No.: US 2024/0378569 A1
(43) Pub. Date: Nov. 14, 2024

(54) Auto Market Rep

(71) Applicant: Houssam Tarabay, San Diego, CA (US)

(72) Inventor: Houssam Tarabay, San Diego, CA (US)

(21) Appl. No.: 18/195,893

(22) Filed: May 10, 2023

(51) Int. Cl. G06Q 10/20

(52) U.S. Cl. CPC G06Q 10/20

(57) ABSTRACT

The Auto Market Rep/My Car App provides a unique solution to the problem of finding reliable and affordable auto service vendors. With the ability to add vehicles and track maintenance needs, consumers can quickly and easily submit service requests to a wide range of vendors with a variety of specialties, including auto repair, auto body, tires, glass, electric, towing, upholstery, and more. The app's special algorithm matches consumers with the most suitable vendors, saving them time and money. The app also offers the ability for vendors to bid on jobs and for consumers to compare quotes, ensuring they receive the best service at the best price. The Auto Market Rep/My Car App is a game-changer for the auto service industry, providing a convenient and efficient way for consumers to manage their auto service needs.

### 1—DETAILED DESCRIPTION

The Auto Market Rep DBA: My Car App is a software application designed to improve the auto purchasing and maintenance process for consumers. The app provides a variety of features that make it easy for consumers to manage their vehicles, find reputable service providers, and buy or sell cars and auto parts.

Upon logging into the app, consumers can navigate to the “My Vehicles” section and add their vehicles by entering the VIN #and decoding the system. The app will generate important vehicle information, and consumers can check for any recalls on the vehicle they added. They can also set multiple reminders for oil changes, tire rotations, insurance, and other important maintenance tasks.

The main page of the app allows consumers to submit requests for auto repair and services, auto body and collision repair, auto electric, tires and wheels, towing, tinting, key and fob (locksmith), auto upholstery, auto detailing, car wash, vehicle vinyl wrapping, buy and sell cars, and buy and sell auto parts. Once the consumer selects a section, they can choose to request a quote and select the vehicle they are referring to. If they have an existing quote, the app gives an option to upload the quote so vendors can bid against it. Consumers can then select if they need mobile or in-shop service, and choose from a list of service specialties, including:
Authorized Auto Repair Dealer (Franchise Auto Brand Dealer)
Diesel Specialist
Electric Vehicles Specialist
Hybrid Specialist
Independent Brand Specialist Shop (Will Send To Vehicle Make Specialist)
Independent Service Center (General Auto Vendor Shop)

After selecting the service needed, consumers have the option to upload pictures to provide the vendor with a better understanding of what's happening. They can then choose a zip code and radius, preferred date and time, and provide a request description before submitting the request.

Vendors within the selected zone and service specialties will receive notifications with the request, and can make a bid or use the app's chat system to connect with the customer and clarify any details before providing a quote and price. Vendors can make more than one bid by changing options such as OEM parts or used parts, and consumers will receive notifications every time they receive a bid so they can compare quotes and choose the best fit for their needs. Consumers also have the option to contact vendors through the app's chat feature.

After accepting a quote, the request will go offline and a notification will be sent to the vendor who provided the accepted quote, including the time and date. When the repair or service is complete, the vendor can mark the job as done, and a notification will be sent to the consumer to rate and write a review about the vendor and their experience. The job will be saved under the vehicle page and follow the vehicle VIN #for future buyers so they can track all service done on the vehicle.

Overall, the Auto Market Rep/My Car App provides a comprehensive solution for consumers to manage their vehicles and find reputable service providers, making the auto purchasing and maintenance process much easier and efficient.

### 3—BACKGROUND

The auto repair and maintenance industry has been experiencing growth in recent years due to the increasing number of vehicles on the road. However, the process of finding the right service vendor and getting the best quote can be a time-consuming and frustrating experience for consumers. Traditional methods such as searching through directories, making phone calls, and visiting vendors in person can be a hassle, and consumers often end up paying more than they should due to lack of transparency in pricing.

Existing technology such as online directories and marketplaces have attempted to address these issues, but they still fall short in providing a comprehensive and efficient solution. Many online directories lack crucial information such as pricing, reviews, and availability, while marketplaces often require consumers to manually request quotes and negotiate with vendors.

The Auto Market Rep/My Car App solves these problems by providing a streamlined and user-friendly platform for consumers to easily find and connect with qualified service vendors in their area. The app offers a wide range of specialty services, including auto repair, auto body, tires & wheels, auto glass, auto electric, towing, upholstery, and more, ensuring that consumers can find the right vendor for their specific needs.

The app's unique algorithm matches consumers with vendors based on their service needs, location, and availability, saving them time and hassle. Additionally, the app offers transparency in pricing by allowing vendors to bid on service requests, giving consumers the ability to compare quotes and choose the best option for their budget.

Overall, the Auto Market Rep/My Car App represents a significant improvement over existing technology in the auto service and maintenance industry, providing a convenient and reliable solution for consumers while also benefiting service vendors by expanding their reach and customer base.

### 4—DETAILED DESCRIPTION

The Auto Market Rep/My Car App is designed to simplify the auto repair and service process by providing consumers with an easy-to-use platform that connects them with qualified service vendors. The app provides a comprehensive solution for consumers seeking auto repair, body and collision repair, auto electric, tires and wheels, towing, tinting, key and fab (locksmith), auto upholstery, auto detailing and car wash, vehicle vinyl wrapping, auto carrier, and jobs services.

Upon logging in, users can add their vehicles to the app by entering the VIN #, which will generate important vehicle information. They can also check for recalls on the vehicle and set reminders for regular maintenance tasks such as oil changes, tire rotations, and insurance.

The main feature of the app is the ability for users to submit service requests to a variety of auto service vendors based on their specific needs. They can select a service category, such as auto repair, and then choose the type of service they require, such as brakes service, check engine light, or suspension alignment. Users can upload pictures to provide vendors with more information about their vehicle and the service needed.

The app uses a special algorithm to match the consumer's request with qualified service vendors in their local area. Vendors in the selected zone and with the selected service specialty will receive a notification of the request and can make a bid or use the app's chat system to connect with the consumer to clarify the request details before filling in the quote and price. Vendors can make more than one bid, changing offer options such as OEM parts or used parts and other options. Consumers will receive notifications every time they receive a bid so they can compare quotes and choose the best option that fits their needs.

Once the consumer accepts a quote, the request will go offline, and a notification will be sent to the vendor with the accepted quote's time and date. After the repair or service is completed, the vendor can mark the job as done, and a notification will be sent to the consumer to rate and write a review about the vendor and their experience. The job will be saved under the vehicle page and will follow the vehicle's VIN #for future buyers so they can track all service done on the vehicle.

Overall, the Auto Market Rep/My Car App provides a convenient, user- friendly solution to the challenges consumers face when seeking auto repair and service. By streamlining the process and connecting consumers with qualified vendors, the app saves time and effort while ensuring that users receive quality service at a fair price.

I. A computer-implemented method for facilitating vehicle repairs and services, comprising:
receiving, from a user device, a request for vehicle repair or service, the request including a vehicle identifier, a service type, and a preferred location for the repair or service;
identifying one or more service providers based on the vehicle identifier, the service type, and the preferred location;
transmitting the request to the identified service providers;
receiving, from one or more of the identified service providers, a bid for the requested repair or service;
transmitting the bid(s) to the user device; and
facilitating communication between the user device and the service provider(s) to finalize the requested repair or service.

II. The method of claim 1, wherein the vehicle identifier is a vehicle identification number (VIN) and the service type is selected from a predefined list of service types.

III. The method of claim 1, further comprising generating one or more reminders for the user device based on the requested repair or service, the reminders being associated with a date and time for completion of the requested repair or service.

IV. A computer-implemented system for facilitating vehicle repairs and services, comprising:
a database of vehicle information including one or more vehicle identifiers and corresponding vehicle information;
a user device configured to transmit a request for vehicle repair or service, the request including a vehicle identifier, a service type, and a preferred location for the repair or service;
a server in communication with the user device and the database, the server configured to identify one or more service providers based on the vehicle identifier, the service type, and the preferred location, transmit the request to the identified service providers, receive one or more bids for the requested repair or service from the identified service providers, and facilitate communication between the user device and the service provider(s) to finalize the requested repair or service.

V. The system of claim 4, further comprising a reminder module configured to generate one or more reminders for the user device based on the requested repair or service, the reminders being associated with a date and time for completion of the requested repair or service.

VI. The system of claim 4, wherein the user device is a mobile device and the server is configured to transmit bid information to the user device using push notifications.

VII. A non-transitory computer-readable medium having stored thereon instructions for facilitating vehicle repairs and services, the instructions comprising:
receiving, from a user device, a request for vehicle repair or service, the request including a vehicle identifier, a service type, and a preferred location for the repair or service;
identifying one or more service providers based on the vehicle identifier, the service type, and the preferred location;
transmitting the request to the identified service providers;
receiving, from one or more of the identified service providers, a bid for the requested repair or service;
transmitting the bid(s) to the user device; and
facilitating communication between the user device and the service provider(s) to finalize the requested repair or service.

VIII. The non-transitory computer-readable medium of claim 7, wherein the vehicle identifier is a vehicle identification number (VIN) and the service type is selected from a predefined list of service types.

IX. The non-transitory computer-readable medium of claim 7, further comprising generating one or more reminders for the user device based on the requested repair or service, the reminders being associated with a date and time for completion of the requested repair or service.

The novel and non-obvious features of the Auto Market Rep/My Car App include its ability to facilitate communication and bidding between users and service providers for vehicle repairs and services based on specific vehicle information, as well as:

I. The system of claim 16, wherein the consumers are able to receive notifications of service completion and are able to rate and provide reviews of the vendors.

II. The system of claim 16, wherein the service requests and information related to the services are stored on a server accessible by the consumers and vendors through the mobile application.

III. A method for facilitating automotive services for a consumer, comprising:
providing a mobile application that enables a consumer to add and manage their vehicles, receive recall information, and set reminders for maintenance and services;
providing a service request section within the mobile application that allows the consumer to submit a service request for a specific service;
enabling vendors to receive notifications of the service requests and submit bids for the requested service;
enabling the consumer to compare the submitted bids and choose the best fit for their needs; enabling the consumer to communicate with the chosen vendor through the mobile application; enabling the vendor to mark the service as complete and receive a rating and review from the consumer.

IV. The method of claim 19, wherein the mobile application allows the consumer to upload pictures of their vehicle to provide more information to the vendors about the service needed.

V. The method of claim 19, wherein the mobile application allows the consumer to select the type of vendor they prefer based on the vendor's specialty and location.

VI. The method of claim 19, wherein the mobile application allows the consumer to track the service history of their vehicle through the app.

VII. The method of claim 19, wherein the mobile application allows vendors to submit multiple bids with different options, such as using OEM or used parts.

VIII. The method of claim 19, wherein the mobile application provides the consumer with the option to select mobile or in-shop services.

IX. The method of claim 19, wherein the mobile application allows vendors to use a chat system to communicate with the consumer about the service request.

X. The method of claim 19, wherein the mobile application allows the consumer to receive notifications about the service request status, including the status of vendor bids and completion of the service.

XI. The method of claim 19, wherein the mobile application provides a platform for buying and selling cars and auto parts, and for finding auto carrier and job opportunities.

XII. The method of claim 19, wherein the mobile application enables vendors to access a platform for managing and tracking their service requests and job completion.

XIII. The Auto Market Rep/My Car App of claim 1, wherein the app includes a specialized algorithm that matches consumer requests for auto repair and services with the most suitable vendor based on location, service type, vendor specialty, and consumer feedback.

XIV. The Auto Market Rep/My Car App of claim 1, wherein the app includes a feature that allows consumers to compare and select vendor quotes based on cost, vendor specialty, location, and other relevant factors.

XV. The Auto Market Rep/My Car App of claim 1, wherein the app includes a feature that allows vendors to submit bids for consumer requests, including the option to bid on OEM or used parts, and allows consumers to communicate with vendors through an in-app chat system.

XVI. The Auto Market Rep/My Car App of claim 1, wherein the app includes a feature that enables vendors to mark jobs as complete and allows consumers to rate and review vendor performance based on the quality of service, time of completion, and other relevant factors.

XVII. The Auto Market Rep/My Car App of claim 1, wherein the app includes a feature that provides consumers with detailed vehicle information, including recalls and maintenance schedules, and allows consumers to set reminders for oil changes, tire rotations, and other regular maintenance needs.

XVIII. The Auto Market Rep/My Car App of claim 1, wherein the app includes a feature that allows vendors to specialize in a variety of auto service areas, including auto repair, auto body, tires, glass, electric, towing, upholstery, and others.
